(19) United States
(12) Patent Application Publication
(10) Pub. No.: US 2008/0227513 A1
(43) Pub. Date: Sep. 18, 2008

(54) Card Gaming Machine And Card Game Playing Method

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/045,219

(22) Filed: Mar. 10, 2008

(30) Foreign Application Priority Data
Mar. 13, 2007 (JP) JP2007-064014

(51) Int. Cl. G06F 17/00

(52) U.S. Cl. 463/12

(57) ABSTRACT

In a card gaming machine, a Blackjack game is carried out. In Blackjack, judgment of winning and losing is made based on comparison between the player's cards and the dealer's cards, and an award responsive to the judgment result is provided. In the case where a side bet is made, a bonus payment determining process is carried out regardless of the result of winning and losing judgment. In the bonus payment determining process, in the player's cards, achievement of a combination relating to a “Pontoon” game different from Blackjack is judged. Then, the contents of the bonus payment responsive to the achieved combination are determined, and the bonus payment is provided to the player.

### CROSS-REFERENCE TO RELATED APPLICATIONS

This application is based upon and claims a priority from the prior Japanese Patent Application No. 2007-064014 filed on Mar. 13, 2007, the entire contents of which are incorporated herein by reference.

### BACKGROUND OF THE INVENTION

1. Field of the Invention

The present invention relates to a card gaming machine and a card game playing method, for judging winning and losing by comparing a player's card and a dealer's card, and awarding corresponding to the results, on condition that a betting of a gaming value is made. In particular, the present invention relates to a card gaming machine and a card game playing method, which are capable of providing different awards independent of the results of the judgment of winning and losing in the case where a side bet of a gaming value is made.

2. Description of the Related Art

Conventionally, card gaming machines and gaming tables are set up in a casino or a game arcade or the like. In these card gaming machines and tables, card games such as Pai Gow Poker, Draw Poker or Blackjack are played. In these card games, cards with marks (numbers or suits) are used. Then, the winning and losing (any one of “player's winning”, “dealer's winning”, and “draw”) in the card game is judged by comparing cards distributed to the player (i.e., the player's card) and cards distributed to the dealer (i.e., the dealer's card). In addition, the contents of award to players are determined based on this judgment result.

As such card games, one described in the specification of U.S. Pat. No. 6,808,173 is known. In this context, Blackjack game is a game for judging winning and losing by comparing a dealer's card and a player's card, and providing awards based on the judgment result.

In the Blackjack game according to the specification of the U.S. Pat. No. 6,808,173, similar to the conventional Blackjack game, first, two cards are distributed to a dealer and a player, respectively. In this context, it is possible to add a card to the first distributed two cards if desired.

In the distributed player's cards and the dealer's cards, the judgment of winning and losing of the player's cards and the dealer's cards is made based on a criterion that a total of numbers displayed in cards does not exceed “21” and is also close to “21”. In other words, in the case where a total of numbers displayed in the distributed cards is closer to “21”, it is determined to be a winner, and in the case where the total is equal, it is determined to be “Draw”. It is determined to be a loser at the time when the total of numbers exceeds “21”.

Then, in the case where the player has won against the dealer, a tip that is 1.5 times of a betting amount betted by the player is awarded. In addition, in the case where the player has lost against the dealer, the tips betted by the player are collected. In the case of a draw, the tips betted by the player are returned to the player.

A card game such as the Blackjack described above has been currently performed worldwide, thus causing a situation that this type of card games cannot attract many players demanding something new. Therefore, there is a necessity for providing a card game that gives more freshness and attraction in order to respond to the player's demand.

The present invention relates to a card gaming machine and a card game playing method, for making determination of the winning and losing by comparing a player's card and a dealer's card, and providing awards based on a judgment result. In particular, it is an object of the present invention to provide a card gaming machine and a card game playing method, in which, in the case where a side bet of a gaming value has been made in the player's card, judgment is made based on a combination specified as a combination of a game different from the game currently executed, thereby making it possible to give a new attraction and to give more sense of expectations to the game of the player.

### SUMMARY

Therefore, in order to achieve the object, according to a first aspect of the present invention, there is provided a card gaming machine comprising: a display for displaying a plurality of cards; an operating unit for receiving an input information from a player; and a game controller for executing the steps of: (a) receiving a betting of a gaming value by the player; (b) making judgment of winning and losing by comparing the player's cards constituted of cards associated with the player with the dealer's cards constituted of cards associated with the dealer from among a plurality of cards displayed on the display; (c) executing a first game for providing to the player a first award that is based on a betted gaming value in response to a result of the judgment of winning and losing; (d) receiving a side bet of a gaming value by the player (e) in a case where the side bet is made, judging whether or not a specified predetermined combination is achieved as a combination in a game different from the first game by cards configuring the player's cards; and (f) providing a second award responsive to the achieved combination.

In a card gaming machine, a first game is executed on condition that betting of a player's gaming value is made. In the first game, judgment of the winning and losing is made by way of comparing the player's cards and the dealer's cards. A first award is provided based on a result of the judgment of the winning and losing and the betted gaming value.

In this context, when a side bet of a gaming value is made in the card gaming machine, judgment relating to achievement of a predetermined combination is made in cards configuring the player's cards. The predetermined combination judged in this context is specified as a combination in a game different from the first game. Then, a second award different from the first award is provided based on a judgment result of the combination. In other words, the player can obtain a chance to acquire the second award by carrying out a side bet. As a result, the card gaming machine can give a sense of expectations to the player of the game.

Judgment of the presence or absence of the second award is made based on the combination specified as a combination of a game different from the first game. In other words, judgment is introduced according to another criterion different from that for the first game, whereby the card gaming machine can give a new attraction to the game. In this manner, the card gaming machine is capable of giving a sense of expectations to the player of the game while giving a new attraction to the player.

According to one or more aspects of the present invention, there is provided a card gaming machine comprising: a display for displaying a plurality of cards; an operating unit for receiving an input information from a player; and a game controller for executing the steps of: (a) receiving a betting of a gaming value by the player; (b) making judgment of winning and losing by comparing the player's cards constituted of cards associated with the player with the dealer's cards constituted of cards associated with the dealer from among a plurality of cards displayed on the display; (c) executing a Blackjack game as a first game for providing to the player a first award that is based on a betted gaming value in response to a result of the judgment of winning and losing: (d) receiving a side bet of a gaming value by the player (e) in a case where the side bet is made, judging whether or not a specified predetermined combination is achieved as a combination in a game different from the Blackjack game by cards configuring the player's cards; and (f) providing a second award responsive to the achieved combination.

In a card gaming machine, a Blackjack game is executed as a first game on condition that a betting of a gaming value of the player is made. In other words, the card gaming machine carries out judgment of the winning and losing by way of comparison of the player's cards and the dealer's cards, based on the rules of the Blackjack game. Then, the card gaming machine provides a first award, based on a result of the judgment of the winning and losing and the betted gaming value.

In this context, if a side bet of a gaming value is made by the card gaming machine, the card gaming machine makes judgment relating to the achievement of a predetermined combination while cards configuring the player's cards are defined as a target. The predetermined combination judged in this context is specified as a combination in a game different from the Blackjack game. Then, based on the result of judgment of the combination, the card gaming machine provides a second award different from the first award. In other words, the player can obtain a chance to acquire the second award by making a side bet. Therefore, the card gaming machine can give the sense of expectations to the player for the game.

In addition, the judgment of the presence or absence of the second award is made based on a predetermined combination specified as a combination (such as a Poker combination, for example) in a game different from the Blackjack game. In other words, the judgment according to another criterion different from that for the Blackjack game is introduced, whereby the card gaming machine can give a new attraction to the game. In this manner, the card gaming machine can give the sense of expectations to the player for the game while giving a new attraction to the player.

According to one or more aspects of the present invention, there is provided a card game playing method comprising the steps of: (a) receiving a betting of a gaming value by a player; (b) making judgment of winning and losing by comparing the player's cards constituted of cards associated with the player with the dealer's cards constituted of cards associated with a dealer from among a plurality of cards displayed on the display; (c) executing a first game for providing to the player a first award that is based on a betted gaming value in response to a result of the judgment of winning and losing; (d) receiving a side bet of a gaming value by the player (e) in a case where the side bet is made, judging whether or not a specified predetermined combination is achieved as a combination in a game different from the first game by cards configuring the player's cards; and (f) providing a second award responsive to the achieved combination.

In the card game playing method, a first game is executed on condition that a betting of a gaming value of the player is made. In the first game, the judgment of the winning and losing is made by way of comparison between the player's cards and the dealer's cards. Then, a first award is provided based on a result of the judgment of the winning and losing and a betted gaming value.

In this context, if a side bet of a gaming value is made, in cards configuring player's cards, judgment relating to the achievement of a predetermined combination is made. The predetermined combination judged in this context is specified as a combination in a game different from the first game. Then, a second award different from the first award is provided based on a judgment result of the combination. In other words, the player can obtain a chance to acquire the second award by making a side bet. As a result, the card game playing method can give a sense of expectations to the player for the game.

In addition, the judgment of the presence and absence of the second award is made based on a combination specified as a combination in a game different from the first game. In other words, judgment according to another criterion different from that for the first game is introduced, whereby the card game playing method can give a new attraction to the card game. In this manner, according to the card game playing method, a sense of expectation to the game of the player can be given while giving a new attraction to the player.

According to one or more aspects of the present invention, there is provided a card game playing method comprising the steps of: (a) receiving a betting of a gaming value by a player; (b) making judgment of winning and losing by comparing the player's cards constituted of cards associated with the player with the dealer's cards constituted of cards associated with a dealer from among a plurality of cards displayed on the display; (c) executing a Blackjack game as a first game for providing to the player a first award that is based on a betted gaming value in response to a result of the judgment of winning and losing: (d) receiving a side bet of a gaming value by the player (e) in a case where the side bet is made, judging whether or not a specified predetermined combination is achieved as a combination in a game different from the Blackjack game by cards configuring the player's cards; and (f) providing a second award responsive to the achieved combination.

According to the card game playing method, a Blackjack game is executed as a first game on condition that a betting of a gaming value of the player is made. Then, a first award is provided according to a result of judgment of the winning and losing.

In this context, if a side bet of a gaming value is made, in cards configuring the player's cards, judgment relating to the achievement of a predetermined combination is made. The predetermined combination judged in this context is specified as a combination in a game different from the Blackjack game. Then, a second award different from the first award is provided based on the judgment result of the combination. In other words, the player can obtain a chance to acquire the second award by making the side bet. Therefore, the card game playing method can give a sense of expectation to the player for the game.

In addition, the judgment of the presence or absence of the second award is made based on a predetermined combination specified as a combination (such as a Poker combination, for example) in a game different from the Blackjack game. In other words, judgment is made according to another criterion different from that for the Blackjack game is introduced. Therefore, the card game playing method can give a new attraction to a card game. In this manner, the card game playing method can give a sense of expectation to the player for the game while giving a new attraction to the player.

One or more aspects of the present invention described above would be fully understood by reading the following detailed description with reference to the accompanying drawings. However, the accompanying drawings are merely provided for the purpose of illustration, and it would be clearly understood that the drawings are not intended to define the limit of the present invention.

### BRIEF DESCRIPTION OF THE SEVERAL VIEWS OF THE DRAWINGS

FIG. 1 is an explanatory view (1) showing a game screen displayed on a liquid crystal display of a player terminal according to one embodiment of the present invention;

FIG. 2 is an outline view of a card gaming machine according to one embodiment of the present invention;

FIG. 3 is an outline view of a player terminal in one embodiment of the present invention;

FIG. 4 is a block diagram showing a control system of the card gaming machine according to one embodiment of the present invention;

FIG. 5 is a block diagram showing a control system of the player terminal according to one embodiment of the present invention;

FIG. 6 is an explanatory view (2) showing a game screen displayed on the liquid crystal display of the player terminal according to one embodiment of the present invention;

FIG. 7 is an explanatory view (3) showing a game screen displayed on the liquid crystal display of the player terminal according to one embodiment of the present invention;

FIG. 8 is an explanatory view showing a main screen displayed on a front display according to one embodiment of the present invention;

FIG. 9 is a flow chart (1) of a game processing program of the card gaming machine according to one embodiment of the present invention;

FIG. 10 is a flow chart (2) of a game processing program of the card gaming machine according to one embodiment of the present invention;

FIG. 11 is a flow chart (3) of a game processing program of the card gaming machine according to one embodiment of the present invention;

FIG. 12 is an explanatory view schematically showing a bonus content determination table of the card gaming machine according to one embodiment of the present invention; and

FIG. 13 is a schematic view showing an example of applying the present invention to a table game.

### DETAILED DESCRIPTION OF THE INVENTION

Hereinafter, an embodiment embodying the present invention has been described in detail with reference to the accompanying drawings.

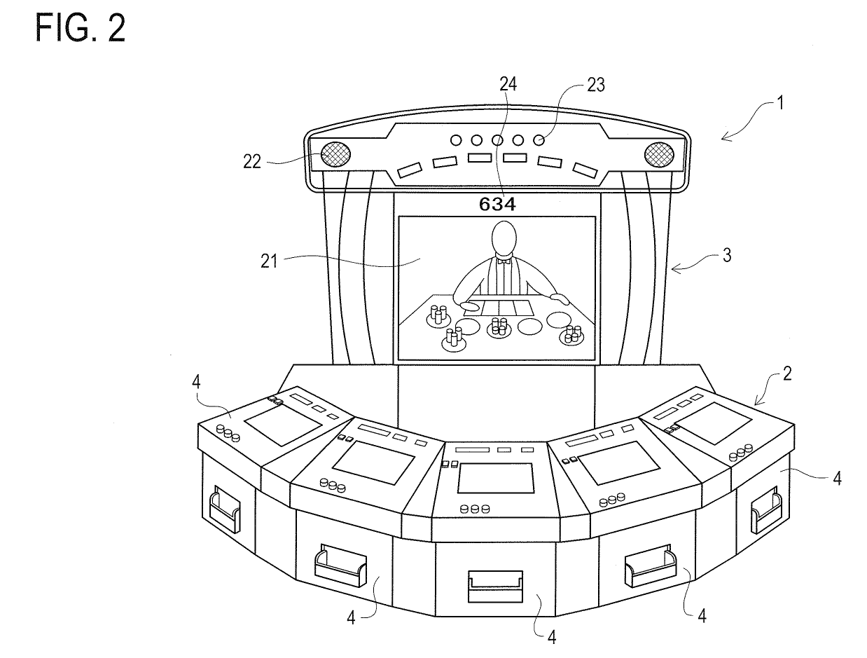

First, an outline of a card gaming machine 1 according to the present embodiment will be described in detail with reference to the accompanying drawings. The card gaming machine 1 according to the present embodiment is a kind of multiplayer participation type gaming machine. Therefore, the card gaming machine 1 is provided with a plurality of player terminals 4 (refer to FIG. 2).

In the card gaming machine 1, Blackjack serving as one of the card games is executed. In this context, in the Blackjack, first, players bet a predetermined amount of tips. If a total in numbers of cards distributed thereafter is closer to “21” than a total of numbers in cards distributed to a dealer, it is determined to be the player winning. In this case, the payout of an award corresponding to the betting amount is carried out.

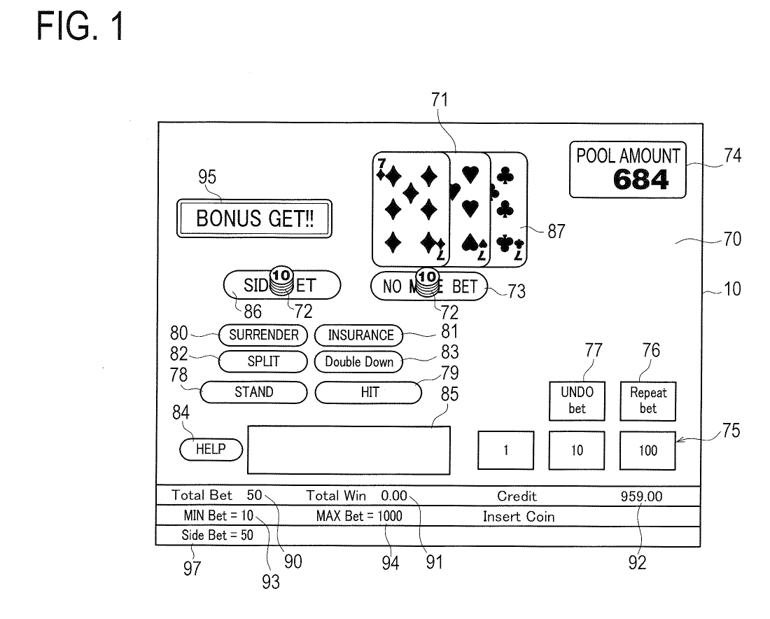

In this context, in the card gaming machine 1 according to the present invention, when the Blackjack game is started, a side bet other than a general bet can be made (refer to FIG. 1). Then, in the case where a side bet is made, the card gaming machine 1 gives a chance to acquire a bonus payment to the player who has made a side bet (i.e., the player terminal 4 of the player) regardless of the winning or losing in the Blackjack game.

The presence or absence of the bonus payment in the card gaming machine 1 is determined based on whether or not a predetermined combination in cards distributed to players in the Blackjack game (hereinafter, referred to as the player's cards) is achieved or not. Specifically, the presence or absence of the bonus payment is determined according to whether or not a “Pontoon” combination that is a game different from the Blackjack game is achieved or not. In the player's cards of the player who has made a side bet, in the case where a combination according to a predetermined “Pontoon” game has been achieved, the bonus payment according to the achieved combination according to the “Pontoon” game is given to the player.

In other words, the card gaming machine 1 according to the present invention is characterized in that, in the case where a side bet by the player is made, a chance to acquire the bonus payment to the player is provided regardless of the winning and losing of the Blackjack game. In addition, the card gaming machine 1 is characterized in that the presence or absence of the bonus payment is determined based on a combination according to the “Pontoon” game that is a game other than the Blackjack game.

First, a general construction of the card gaming machine 1 according to the present embodiment will be described in detail with reference to the accompanying drawings. FIG. 2 is an outline view of the card gaming machine 1 according to the present embodiment.

The card gaming machine 1 according to the present embodiment is basically constructed from a table portion 2 and a panel portion 3. The table portion 2 is a portion that the player plays a game by taking a seat, and is constructed from the plurality of player terminals 4 described above. On the other hand, the panel portion 3 is set up in a front direction of the player taking a seat at the table portion 2. This panel portion 3 is provided with a front display 21, as described later. The front display 21 displays an animation image of the dealer or the like with the progress of a game.

Next, the table portion 2 constructing the card gaming machine 1 will be described in detail with reference to the accompanying drawings. As shown in FIG. 2, at the table portion 2, a plurality of player terminals 4 (5 terminals in FIG. 2) are arranged and constituted in a substantially fan-like shape. Each of the player terminals 4 is also called a satellite.

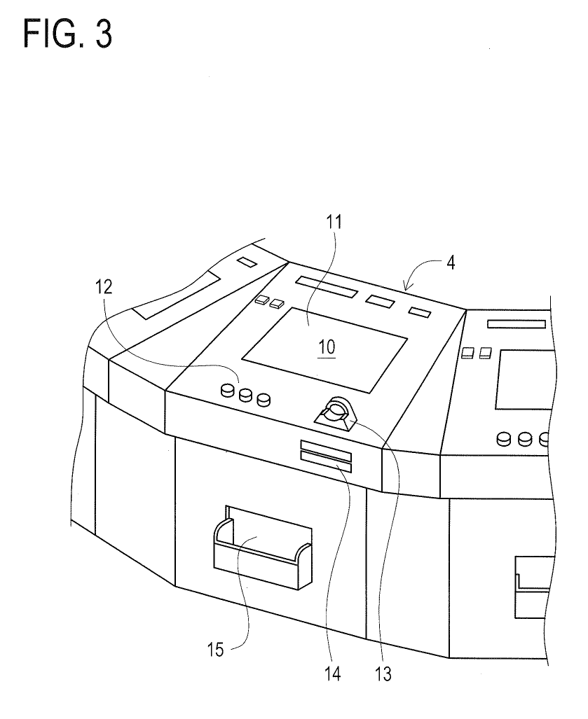

In this context, a construction of one player terminal 4 that constructs the table portion 2 will be described in detail with reference to the accompanying drawings. FIG. 3 is an outline view showing one player terminal 4 according to the present embodiment. Each of the player terminals 4 constructing the table portion 2 is constructed in the same manner.

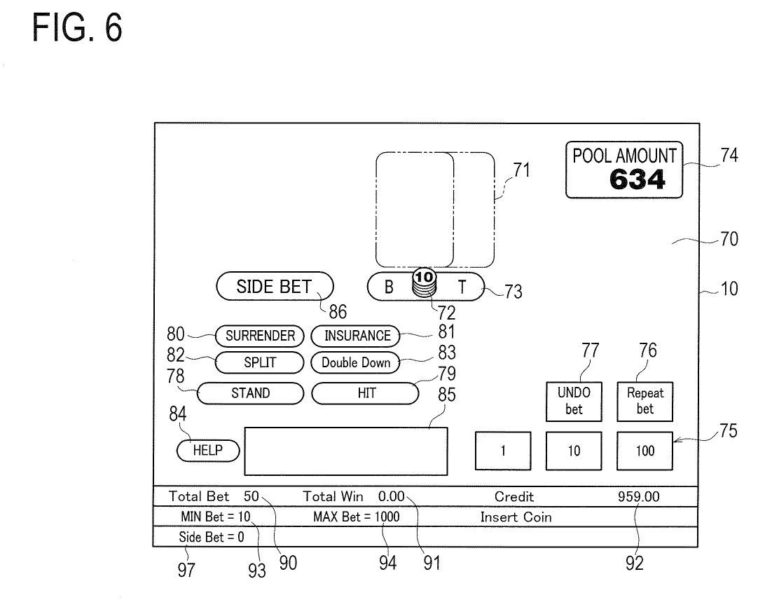

As shown in FIG. 3, one player terminal 4 is constructed from a liquid crystal display 10, a touch panel 11, an operating button 12, a coin insertion slot 13, a bill insertion portion 14, and a coin payout opening 15. The liquid crystal display 10 is a display device that displays a game screen (refer to FIG. 1 and FIG. 6) and/or the results of the game or the like described later. The touch panel 11 is arranged on a front face of the liquid crystal display 10. In the case where a game screen 70 is displayed on the liquid crystal display 10, the touch panel 11 is used to select a betting target or to set a betting amount. Thus, the touch panel 11 functions as an operating unit for selecting the betting target or setting the betting amount. The operating buttons 12 are operating units for making a payout operation or the like in the card gaming machine 1. In addition, the coin insertion slot 13 is a portion for a player to insert coins or medals. The bill insertion portion 14 is a portion for a player to insert bills. Further, the coin payout opening 15 is a portion for paying out coins or medals corresponding to credits accumulated when the player's payout operation has been made.

On the other hand, a panel portion 3 constructing the card gaming machine 1 is constructed from a front display 21, a speaker 22, and an LED 23. The front display 21 is a display device that displays an image together with the progress of the game. Specifically, the front display 21 displays an image or the like of the dealer who distributes cards or exchange tips. In addition, the front display 21 also displays the contents of distributed cards. The speaker 22 outputs music and/or sound effects in accordance with the progress of the game. This speaker 22 is set up at the upper portion of the front display 21. Then, the LED 23 is a light emitting device that is lit at the time of various effects, and enhances the sense of reality of the game by means of the effect exerted by light emitting mode.

A pool amount display portion 24 is provided at the upper portion of the front display 21. In this context, in the card gaming machine 1 according to the present embodiment, as described later, in the case where “Draw” has been judged by the judgment of the winning and losing in Blackjack, the betting amount betted by the player in that game is pooled in a pot. In other words, the pool amount display portion 24 displays a current pool amount accumulatively added to the pot.

Although described in detail later, the pot amount accumulatively added to the pot is paid out in all to the corresponding player as a bonus payment in the case where a predetermined condition is met.

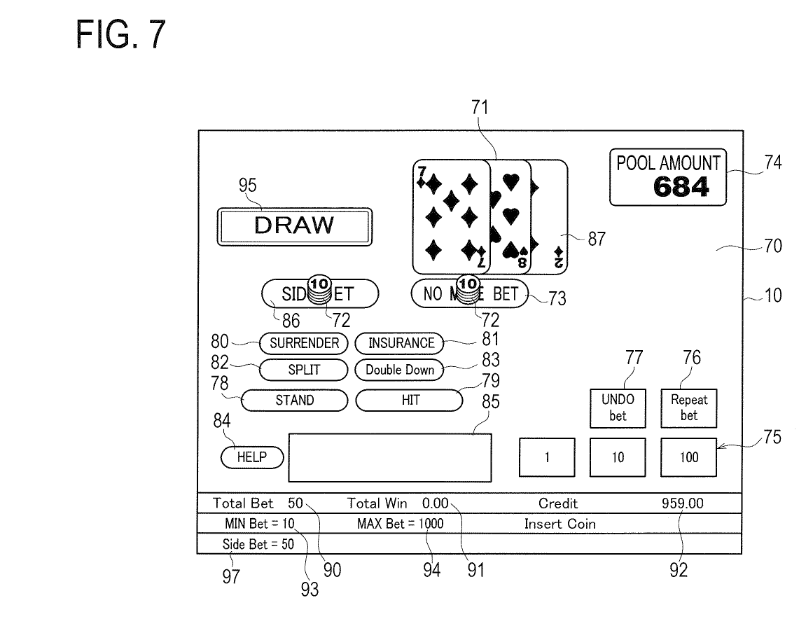

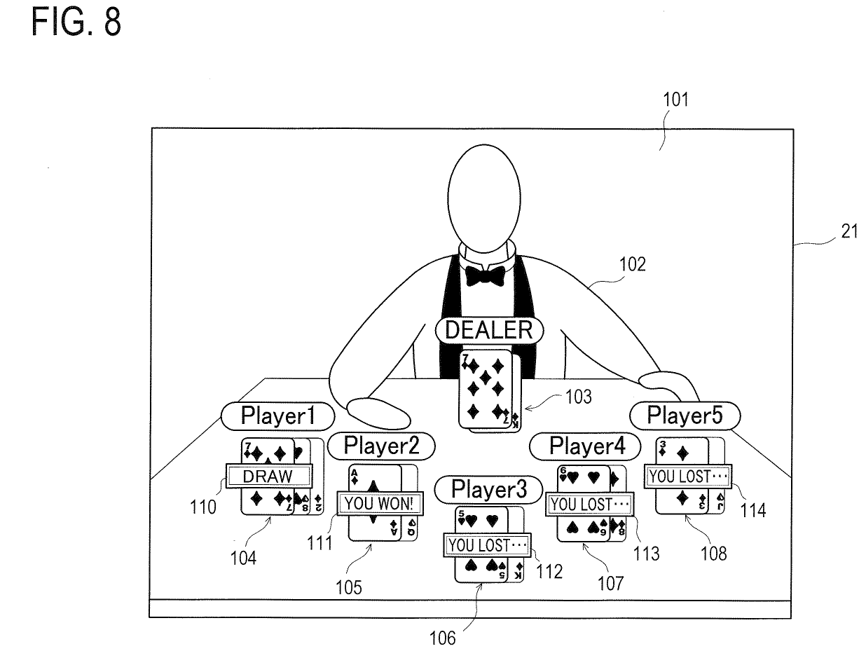

Cards used in the card gaming machine 1 according to the present invention are identical to playing cards (trump cards) that are generally used. In other words, “suits” and “numbers” are associated with each other in each card (refer to FIG. 1, FIG. 7, and FIG. 8).

In this context, the “suits” are marks of the cards. The “suits” have four types, i.e., Spade, Heart, Diamond, and Club.

In addition, “numbers” are numbers or alphabets of the cards. The “numbers” have 13 types of A (Ace, equivalent to 1), 2, 3, 4, 5, 6, 7, 8, 9, 10, J (Jack, equivalent to 11), Q (Queen, equivalent to 12), and K (King, equivalent to 13).

Next, a playing method of the card gaming machine according to the present embodiment will be described. In the case of playing a game in the card gaming machine 1, the player takes a seat in front of the player terminal 4, and bets a desired betting amount to the Blackjack game with the use of the game screen displayed on the liquid crystal display 10. At this time, the player can made a side bet in order to obtain a chance to acquire a bonus payment.

After that, in the card gaming machine 1, card images distributed to the player and the dealer are displayed on the front display 21 and each liquid crystal display 10. Then, the judgment of winning and losing is made based on the numbers and suits of the cards distributed to the player (i.e., the player's cards) and the cards distributed to the dealer (i.e., the player's cards).

After the judgment, in the card gaming machine 1, an image effect is displayed according to the result of the judgment. Further, credits that is 1.5 times of the betted amount (credit amount) is provided as an award to the player terminal 4 of the player having won against the dealer. On the other hand, no award is provided to the player terminal 4 having lost against the dealer. In this context, while no award is provided to the player terminal 4 having drawn against the dealer, as is the case with losing, the betted amount (credit amount) betted by the player is pooled in the pot.

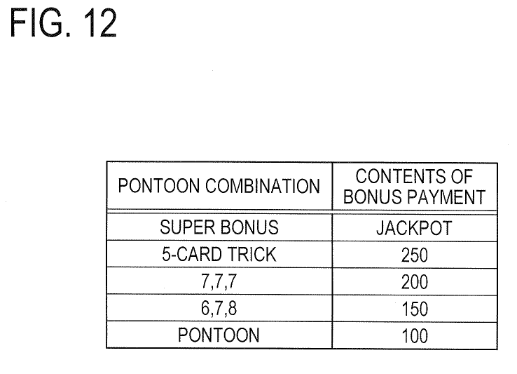

In this context, in the case where the player has made a side bet, the card gaming machine 1 gives a chance to acquire a bonus payment to the player. Specifically, the card gaming machine 1 makes judgment relating to the achievement of a predetermined combination (refer to FIG. 12), while the player's cards at the time of judgment is defined as the target, and provides the bonus payment corresponding to the achieved combination. A “Pontoon” combination that is a game different from Blackjack is used as a combination according to this bonus payment (refer to FIG. 12). In the case where the combination according to the predetermined “Pontoon” is achieved, the bonus payment is provided to the player based on the contents of the bonus payment specified for the respective combination.

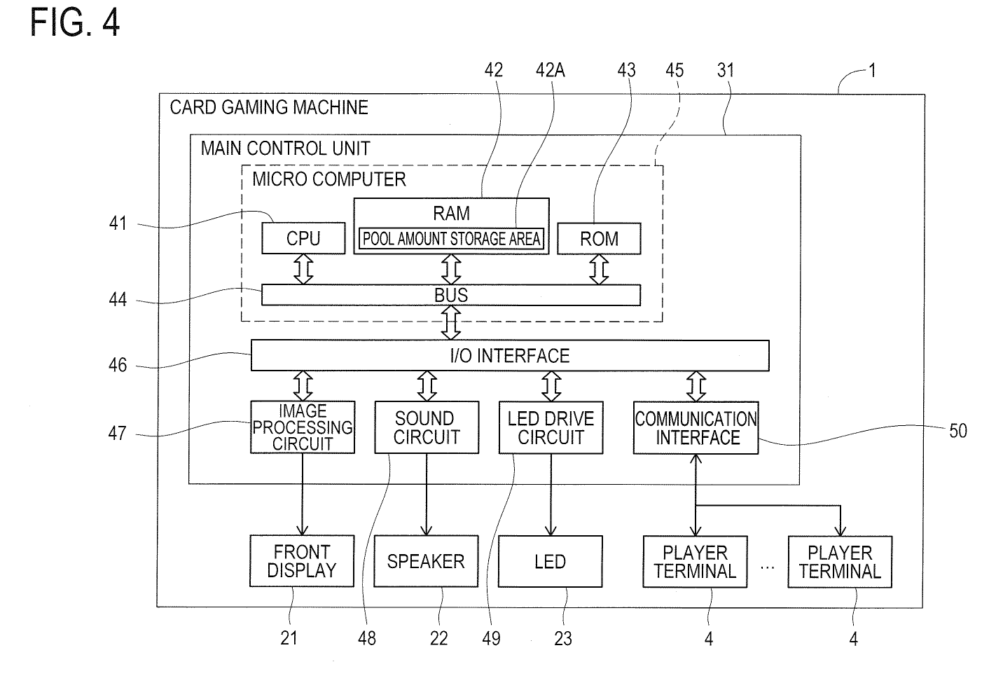

Next, a construction according to a control system of the card gaming machine 1 will be described in detail with reference to the accompanying drawings. FIG. 4 is a block diagram schematically showing the control system of the card gaming machine 1 according to the present embodiment.

As shown in FIG. 4, the card gaming machine 1 is constructed from a main control unit 31, a plurality of player terminals 4 connected to the main control unit 31, and a variety of peripheral devices.

The main control unit 31 basically includes a microcomputer 45 as a core. This microcomputer 45 includes a CPU 41, a RAM 42, a ROM 43, and a bus 44 for transmitting data among the CPU 41, the RAM 42 and the ROM 43. The ROM 43 stores a various programs necessary for executing processes to control the gaming machine 1 and a data tables are stored. The CPU 41 is a calculating unit that executes various control programs. The CPU 41 is primarily responsible for control by the microcomputer 45. In addition, the RAM 42 is a memory for temporarily storing various data calculated by the CPU 41. In addition, a pool amount storage area 42A is provided in the RAM 42. The pool amount pooled in the pot is accumulatively stored in this pool amount storage area 42A.

Further, the ROM 43 stores image data of top sides and backsides of cards used for the player's cards and the dealer's cards.

In addition, the CPU 41 is connected to an image processing circuit 47, a sound circuit 48, an LED driving circuit 49, and a communication interface 50 through an I/O interface 46. The image processing circuit 47 is a circuit for controlling a display mode of the front display 21, based on control by the CPU 41. Therefore, an image of the dealer 102 or the like is displayed on the front display 21 by making a display control of the front display 21 through the image processing circuit 47 (refer to FIG. 8). The sound circuit 48 is a circuit for making a drive control of the speaker 49, based on the control by the CPU 41. In other words, the music and sound effects according to the progress of the game are outputted by controlling the speaker 22 through the sound circuit 48. The LED driving circuit is a circuit for controlling an illumination mode of the LED 23. Therefore, by means of the LED driving circuit 49, effects corresponding to the progress of the game can be carried out by controlling the illumination mode of the LED 23.

The communication interface 50 is an interface for transmitting various data between each player terminal 4 and a main control unit 31. Therefore, various information such as a betting operation information from each player terminal 4 is transmitted between the main control unit 31 and each player terminal 4 through the communication interface 50.

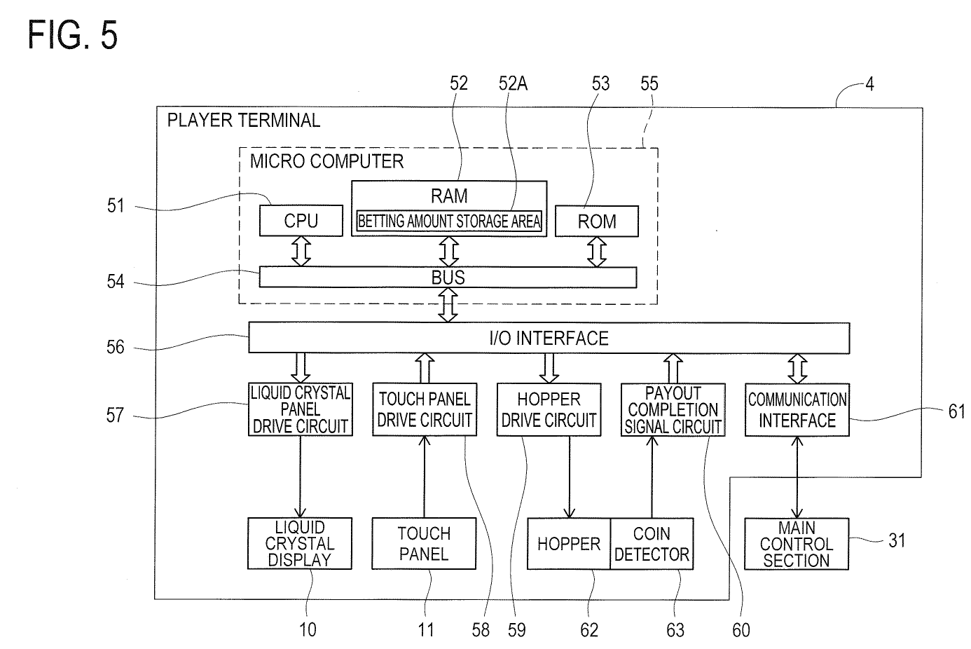

Next, the control system of the player terminal 4 according to the present embodiment will be described in detail with reference to the accompanying drawings. FIG. 5 is a block diagram schematically showing the control system of the player terminal 4 according to the present embodiment.

As shown in FIG. 5, the player terminal 4 according to the present embodiment includes a microcomputer 55 as a core. The microcomputer 55 includes a CPU 51, a RAM 52, a ROM 53, and a bus 54 for transmitting data among the CPU 51, the RAM 52, the ROM 53. The ROM 53 stores various programs necessary for executing processes to control the player terminals 4 and data tables are stored. The CPU 51 is a calculating unit that executes a variety of control programs stored in the ROM 53. The CPU 51 is primarily responsible for control by the microcomputer 55. The RAM 52 is a memory for temporarily storing various data calculated by the CPU 51. In addition, a betting amount storage area 52A is provided in the RAM 52. The RAM 52 stores a credit amount currently accumulated in the player terminal 4, a betting target betted by the player (i.e., bet or side bet), and the betting amount (credit amount) betted for the betting target.

In addition, the CPU 51 is connected to a liquid crystal panel driving circuit 57, a touch panel driving circuit 58, a hopper driving circuit 59, a payout complete signal circuit 60, and a communication interface 61 through an I/O interface 56.

The liquid crystal panel driving circuit 57 is connected to the liquid crystal display 10, and is used for control a display mode of the liquid crystal display 10. The touch panel driving circuit 58 is connected to the touch panel 11, senses operation of the touch panel 11 by the player, and is used for carrying out control that corresponds to the operation. The hopper driving circuit 59 is connected to a hopper 62, and is used for controlling the hopper 62 at the time of paying out coins to the coin payout opening 15. The payout complete signal circuit 60 is connected to a coin detection portion 63. In the case where a predetermined number of coins are paid out to the coin payout opening 15, the payout complete signal circuit 60 transmits a payout complete signal indicating that payout has completed.

The communication interface 61 is an interface used for transmitting various information between the player terminals 4 and the main control unit 31. For example, the betting information based on an operational information outputted from the touch panel 11 is transmitted to the main control unit 31 through the communication interface 61.

Next, with reference to the accompanying drawings, a detailed description will be given with respect to the game screen 70 displayed on the liquid crystal display 10 of the player terminal 4 when the Blackjack game is executed in the card gaming machine 1 according to the present embodiment. FIG. 6 and FIG. 7 are explanatory views showing the game screen 70 displayed on the liquid crystal display 10 of the player terminal 4.

In this context, in the card gaming machine 1 according to the present embodiment, the player makes a betting operation by using the game screen 70 and the touch panel 11. This betting operation is an operation of betting or side-betting a predetermined amount of credits to a current game. Similarly, by using the game screen 70 and the touch panel 11, the player can make an operation for requesting the additional cards (i.e., the player's cards) or an operation or the like of increasing the betted amount.

As shown in FIG. 6 and FIG. 7, the game screen 70 is constructed from a player's card display area 71, a betting display area 73, a side bet display area 86, a pool amount display area 74, and an information display area for displaying various operating buttons and player's information.

The player's card display area 71 is an area for displaying the player's cards distributed as the player's cards at the time of Blackjack. Therefore, a card image 87 of the player's cards is displayed in the card display area 71 (refer to FIG. 6 and FIG. 7). The betting display area 73 is a display area for displaying a tip image 72 indicative of tips betted on Blackjack. In addition, the side bet display area 86 is a display area for displaying a tip image 72 indicative of side-betted tips. The pool amount pooled in the pot is displayed in the pool amount display area 74.

The information display area displays player's information such as a betting amount display area 90 together with various operating buttons such as a BET button 75 or a Repeat betting button 76.

The player's card display area 71 is a display area for displaying a card image 87 indicative of the player's cards distributed to a player. In other words, the plurality of card images 87 displayed on the player card display area 71 indicates cards distributed to the player who plays the game while taking a seat at the player terminal 4.

As described above, a tip image 72 equivalent to the betting amount betted to the Blackjack game by the player is displayed in the betting display area 73 (tips for 50 credits are betted in FIG. 6 and FIG. 7, for example). In the case of making this betting, the player sets a betting amount by the BET button 75 described later, and touches a portion of the touch panel 11 corresponding to the betting display area 73. In this manner, the player determines a betting amount to the bet display area 73. In other words, the portion of the touch panel 11 corresponding to the betting display area 73 functions as a selecting unit of the betting target (i.e., betting to the Blackjack game). The betting amount determined by operation to the portion of the touch panel 11 corresponding to the betting display area 73 is transmitted to the main control unit 31.

Then, the tip image 72 equivalent to the betting amount side-betted by the player is displayed in the side bet display area 86 (tips for 50 credits are betted in FIG. 7, for example). In the case of making this side bet, the player sets a betting amount by the BET button 75 described later, and then, touches a portion of the touch panel 11 that corresponds to the side bet display area 86. In this manner, the player determines a bet amount to be side-betted. In other words, the portion of the touch panel 11 corresponding to the side bet display area 86 also functions as a selecting unit of the betting target (i.e., side bet). The betting amount determined by operation to the portion of the touch panel 11 corresponding to the side bet display area 86 is transmitted to the main control unit 31.

The pool amount display area 74 is an area indicating a pool amount that has been pooled in the pot. In this context, in the card gaming machine 1 according to the present embodiment, in the Blackjack game, in the case where the game between the player and the dealer has drawn, all of the betting amount betted by the player are pooled in the pot (50 credits are pooled in FIG. 1, for example). It is to be noted that the amount to be pooled may be part of the betted amount (for example, 50%). In that case, it is desirable that the remaining betted amount that has not been pooled be paid out to the player.

In addition, on the lower right portion of the betting display area 73, a plurality of betting buttons 75 (three types of “1 credit”, “10 credits”, and “100 credits” in the present embodiment) are arranged. The player can set a betting amount to be betted to a current game by touching the BET button 75.

On the upper portion of the BET button 75, a Repeat betting button 76 and an UNDO betting button 77 are arranged. The player can bet a betting amount equal to that of the previous game by touching the Repeat betting button 76. In addition, the player can cancel the betting operation that has already been made, by touching the UNDO betting button 77.

On the other hand, on the lower portion of the betting display area 73 and the side bet display area 86, a plurality of operating buttons are arranged. These buttons are used for the player to carry out the underlying strategy with the dealer. Specifically, as operating buttons, a STAND button 78, a HIT button 79, a SURRENDER button 80, an INSURANCE button 81, a SPLIT button 82, and a Double Down button 83 are arranged.

The STAND button 78 is operated at the time of playing against the dealer with cards currently distributed without requiring distribution of additional cards. Then, the HIT button 79 is operated when an additional card is newly requested to the currently distributed cards.

The HIT button 79 can be used until a total of numbers displayed in the distributed cards is equal to or greater than “21”.

The SURRENDER button 80 is operated at the time of withdrawal from the current game. When the SURRENDER button 80 is operated, half of the betted amount at that time is collected, and the remaining betted amount is returned to the player. Then, the INSURANCE button 81 is operated when the player applies insurance for a case in which cards distributed to the dealer becomes Blackjack.

The SPLIT button 82 is operated in the case where numbers displayed on two cards distributed in the game are the same, and the cards are divided into two hands. When the SPLIT button 82 is operated, the player can play with the dealer by two groups or more of a hand. The Double Down button 83 is operated in the case where the player doubles the betted amount in the game.

In addition, on the lower portion of the STAND button 78, a HELP button 84 is arranged. The HELP button 84 is operated when an operating method of the card gaming machine 1 is displayed on the liquid crystal display 10. In addition, on the right side of the HELP button 84, a message area 85 is arranged. A message supporting the progress of the game is displayed in this message area 85.

On the lower portion of the game screen 70, a betting amount display area 90, an acquired amount display area 91, an owned credit display area 92, a betting amount lower limit display area 93, a betting amount upper limit display area 94, and a side bet amount display area 97 are arranged.

A betting amount betted by the player to one game of a current Blackjack is displayed in the betting amount display area 90. The credit amount acquired as an award by the player is displayed in the acquired amount display area 91. Then, a credit amount currently owned by the player is displayed in the owned credit display area 92. A lower limit of the betting amount that can be betted by the player is indicated in the betting amount lower limit display area 93, and an upper limit of the betting amount that can be betted by the player is indicated in the betting amount upper limit display area 94.

Then, a side bet amount that is side-betted by the player to the current game is displayed in the side bet amount display area 97.

In addition, on the left side of the player's card display area 71, a winning and losing display area 95 is arranged.

A character string indicating winning and losing between the player and the dealer in the current game is displayed in the winning and losing display area 95. For example, in the case where the player has won, characters “YOU WON” are displayed in the winning and losing area 95. Then, in the winning and losing display area 95, characters “YOU LOST” are displayed in the case where the player has lost, and characters “DRAW” are displayed in the case where the game has drawn.

As described later, if a bonus payment is acquired as a result of making a side bet, a character string such as “BONUS GET!!” is displayed in the winning and losing display area 95.

In this context, in the winning and losing of Blackjack, in the case where a total of numbers of distributed cards does not exceed “21”, and is closer to “21”, it is determined to be a winner, and in the case where the total is the same, it is determined to be a draw. At this time, in the player's cards, whether or not a combination according to the “Pontoon” game is achieved does not affect the judgment of winning and losing in Blackjack. In other words, the winning and losing of Blackjack is judged based on numbers and suits of the player's cards in accordance with the rules of Blackjack.

Next, with reference to the accompanying drawings, a detailed description will be given with respect to a main screen 101 displayed on the front display 21 at the time of carrying out Blackjack in the card gaming machine 1 according to the present embodiment. FIG. 8 is an explanatory view of the main screen 101 displayed on the front display 21.

In the card gaming machine 1 according to the present embodiment, on the main screen 101, various images are displayed together with the progress of the game. Specifically, an image of the dealer 102 is displayed on the main screen 101, and the dealer who carries out card distribution or the like is expressed by of an animation. By displaying such main screen 101, the card gaming machine 1 gives the sense of reality to the player of the game.

In addition, on the substantially center portion of the main screen 101, a dealer's card image 103 is displayed. The dealer's card image 103 indicates the dealer's cards distributed to the dealer. Further, on the lower portion of the main screen 101, player's card images 104 to 108 indicating the player's cards of players (a maximum of 5 players) who play the game at the player terminals 4 and the winning and losing result images 110 to 114 indicating winning and losing between each of the players and the dealer are displayed.

Therefore, the player can grasp types of cards distributed to the dealer and/or types of cards distributed to the other players who play the game at the same time by referring to the main screen 101. Further, the player can grasp the result of winning and losing of the other players together with the result of one's own winning and losing by referring to the main screen 101.

Next, with reference to the accompanying drawings, a detailed description will be given with respect to a game processing program executed by the CPU 41 of the main control unit 31, and a game processing program at the player terminal side executed by the CPU 51 of the player terminal 4 in the card gaming machine 1 having the above construction according to the present embodiment.

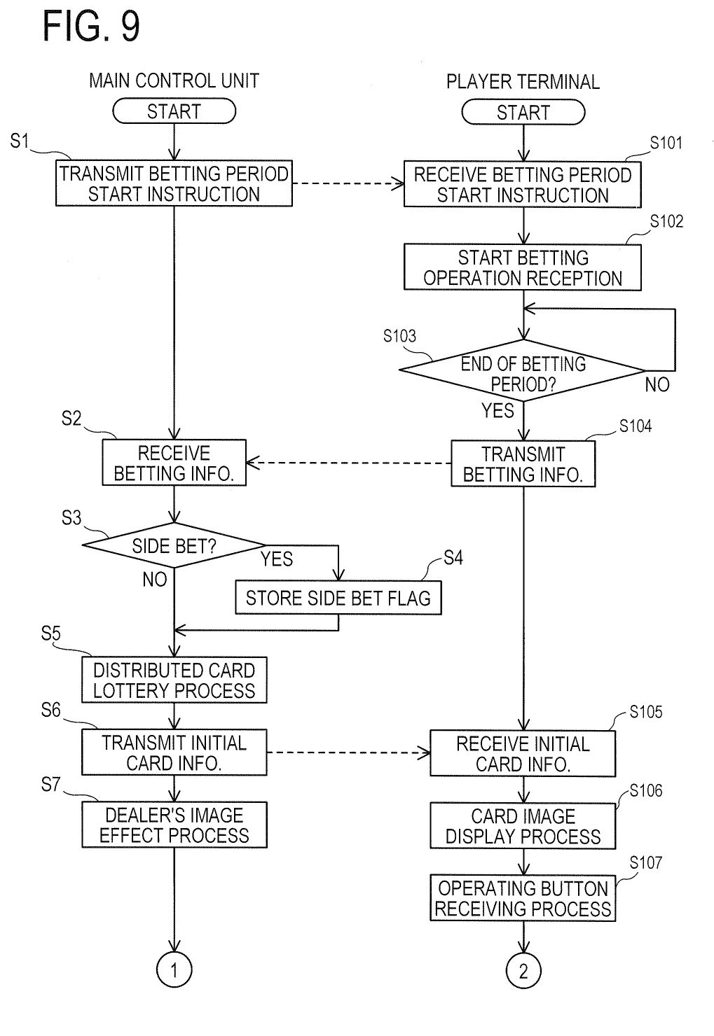

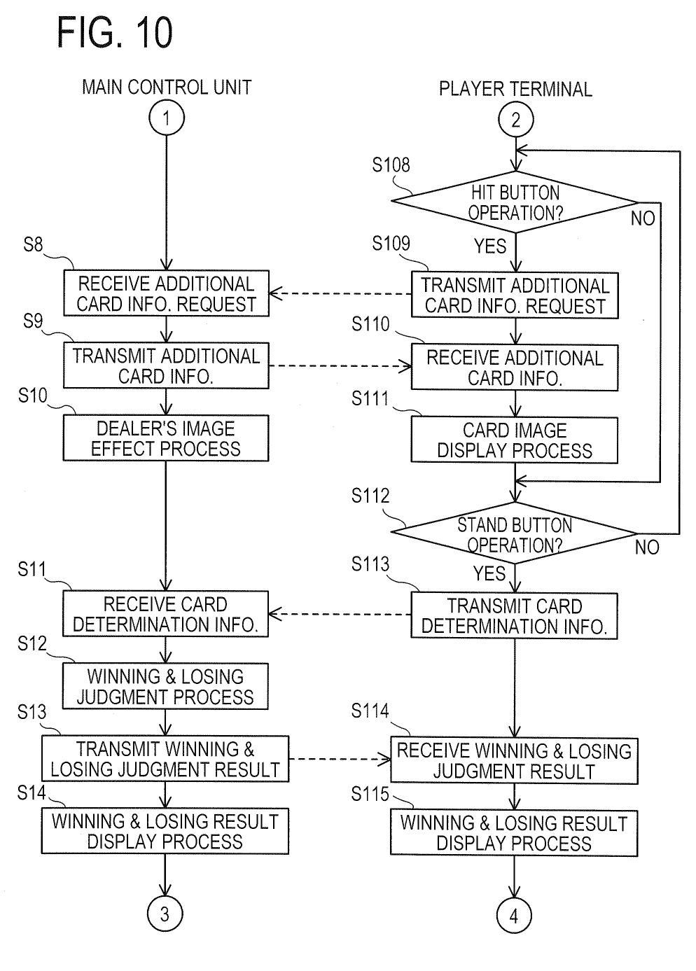

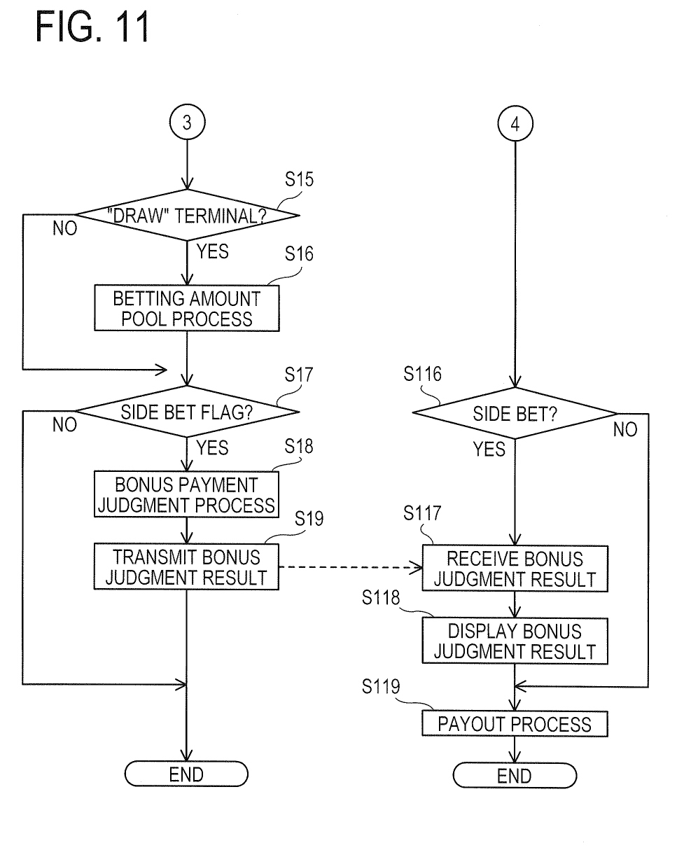

FIG. 9 to FIG. 11 are flow charts of game control programs executed at the side of the main control unit 31 and at the side of the player terminals 4.

Each of these programs shown in FIG. 9 to FIG. 11 is stored in the RAM 42 and/or the ROM 43 provided in the main control unit 31, and the RAM 52 and/or the ROM 53 provided in the player terminals 4. These programs are executed by the CPU 41 or the CPU 51, respectively.

First, with reference to FIG. 9 to FIG. 11, the game processing program executed by the main control unit 31 will be described.

When the main control unit 31 starts the game processing program, the CPU 41 first transmits a betting period start instruction to each player terminal 4 (S1). This betting period start instruction is an instruction for starting reception of a betting operation by the player at each player terminal 4.

After that, when the current step proceeds to S2, the CPU 41 receives a betting information transmitted from each player terminal 4. In this context, the betting information includes information relating to the betting amount (credit amount) betted by the player and information relating to a side bet.

Upon the reception of the betting information, the CPU 41 stores the betting information in the RAM 42 by player terminal 4, and then, proceeds to S3.

When the current step proceeds to S3, the CPU 41 makes judgment as to whether or not a side bet has been made in the betting period described above. Specifically, the CPU 41 specifies the presence or absence of the side bet by referring to the betting information on each player terminal 4 stored in the RAM 42. In the case where the side bet has been made (S3: YES), the CPU 41 stores a side bet flag indicating that the side bet has been made, in the RAM 42 in association with the player terminal 4 at which the side bet has been made (S4). After that, the CPU 41 proceeds to S5. On the other hand, in the case where the side bet has not been made (S3: NO), the CPU 41 proceeds to S5 directly.

After that, the CPU 41 carries out a distributed card lottery process (S5). The distributed card lottery process (S5) is a process for determining cards associated with each player and dealer by means of lottery.

In this context, in the Blackjack game, playing cards of six decks or eight decks are used. The playing cards in 1 deck are constituted of 52 cards assigned with the numbers and suits described above.

Therefore, in the distributed card lottery process (S5), the CPU 41 randomly associates any of numbers from 1 to N (distribution order) with N cards (for example, N=312 in the case where 6 decks are used.) The CPU 41 associates cards with the dealer and the player based on the thus-determined distribution order (in other words, the dealer's cards and the player's cards are distributed to the dealer and the player).

Following the distributed card lottery process (S5), in S6, the CPU 41 transmits an initial card information to the player terminal 4 having received the betting information, based on a lottery result of the distributed card lottery process (S5). In this context, the initial card information is information relating to two cards to be first distributed to players who participate in Blackjack. Namely, the initial card information includes information indicating numbers of first two cards to be distributed and information and suits (such as “Heart 7”, “Spade A”, for example).

After the initial card information has been transmitted to the player terminal 4 at which the betting operation has been made, the CPU 41 executes a dealer's image effect process (S7). Specifically, the CPU 41 controls the front display 21 and carries out an effect of displaying an image of the dealer who distributes two cards of the main screen 101 (refer to FIG. 2) to the player and the dealer.

The numbers and suits of the second card distributed to the dealer are not displayed at the time when the card is distributed.

Next, when the current step proceeds to S8, the CPU 41 receives an additional card information request transmitted from the player terminal 4. The additional card information request is transmitted in response to operation of the HIT button 79 in the player terminal 4, and indicates the fact that a request is made for the player terminal 4 to distribute a new card. The cards to be newly distributed by operation of the HIT button 79 are referred to as an additional card.

The CPU 41 transmits the additional card information relating to the player terminal 4 to the player terminal 4 having requested the additional card information (S9). In this context, the additional card information is constituted of information indicating the third and subsequent cards upon the request. Therefore, this additional card information includes numbers and suits of cards corresponding to the request.

When the current step proceeds to S10, the CPU 41 controls the front display 21, and displays an image of the dealer who distributes the additional card to the player having requested the additional card information on the main screen 101.

In the following S11, the CPU 41 receives a card determination information transmitted from each player terminal 4.

The card determination information is information to be transmitted in the case where the player has selected that the game with the dealer is played with the cards currently distributed. Therefore, the card determination information is transmitted to the main control unit 31 by way of selection of the STAND button 78 at the player terminal 4.

Upon the reception of the card determination information, the CPU 41 determines the presence or absence of additional cards relative to the dealer's cards in accordance with the rules of Blackjack, and determines the dealer's cards including additional cards. Then, the CPU 41 compares the dealer's cards with each of the player's cards, and judges winning and losing between each player and the dealer (S12). Specifically, a total of numbers displayed on the dealer's cards and a total of numbers displayed on the player's cards are calculated, and in the case where the total of numbers is closer to “21” without exceeding “21”, it is determined to be a winner.

In the case where the total of numbers of the player's card and a total of numbers of the dealer's card are the same, the CPU 41 judges to be a draw.

Then, when the current step proceeds to S13, the CPU 41 transmits a result of winning and losing judgment of a winning and losing judgment process (S12) to each player terminal 4. After that, as shown in FIG. 7, the CPU 41 displays winning and losing result images 110 to 114 indicating the result of winning and losing judgment of each player terminal 4 on the main screen 101 of the front display 21 (S14).

Next, when the current step proceeds to S15, the CPU 41 judges whether or not there is the player terminal 4 judged to be a draw in the result of winning and losing judgment of the winning and losing judgment process (S12). In the case where the player terminal 4 having drawn against the dealer (S15: YES), the CPU 41 reads out from the RAM 42 the betting amount betted at the player terminal 4 judged to be a draw. Then, the CPU 41 accumulatively adds the betting amount to the pool amount stored in the pool amount storage area 42A (S16). In other words, the CPU 41 pools the betting amount betted by the player having drawn in the pool amount storage area 42A. After the betting amount has pooled in the betting amount storage area 52A, the CPU 41 proceeds to S17. On the other hand, in the case where there is no player terminals 4 judged to be a draw (S15: NO), the CPU 41 proceeds to 17 directory.

When the current step proceeds to S17, the CPU 41 makes judgment as to whether or not a side bet flag is stored, by referring to the RAM 42. In other words, the CPU 41 judges whether or not there is the player terminal 4 at which a side bet has been executed.

In the case where the side bet flag is stored (S17: YES), the CPU 41 proceeds to S18 in order to give the player a chance to acquire the bonus payment. On the other hand, in the case where the side bet flag is not stored (S17: NO), the CPU 41 terminates the game processing program as it is.

The processing operations after S18 are executed only for the player terminal 4 at which a side bet has been made. In other words, at the player terminal at which a side bet has not been made, a chance to acquire the bonus payment is not given, and waits until the processing operations of S18 and S19 terminate.

When the current step proceeds to S18, the CPU 41 executes a bonus payment determining process as to the player's cards relevant to the player of the player terminal 4 at which a side bet has been made (hereinafter, referred to as a “target player terminal”) (S18). Specifically, the CPU 41 acquires the card determination information relating to the target player terminal by referring to the RAM 42. In this manner, the CPU 41 can acquire a construction of the player's cards of the target player terminal at the time of judgment of winning and losing (in other words, numbers and suits of cards configuring the player's cards). Then, the CPU 41 makes judgment as to the achievement of a combination relating to the “Pontoon” game in the player's cards of the target player terminal, based on the card determination information relating to the target player terminal and the bonus content determination table (refer to FIG. 12).

In the player's cards of the target player terminal, in the case where a combination relating to the “Pontoon” game specified in the bonus content determination table is achieved, the contents of awards corresponding to the achieved combination are determined as a “bonus payment”. In this regard, in the case where any combination specified in the bonus content determination table is not achieved, the CPU 41 determines the bonus payment to be “0”.

In this context, the bonus content determination table will be described with reference to FIG. 12. As shown in FIG. 12, in the bonus content determination table, combinations relating to plural types of “Pontoon” games such as “Super Bonus” and “5-card Trick” are specified, and the contents of awards are specified with respect to the respective combinations.

The “Super Bonus” is a combination in the “Pontoon” game achieved in the case where all of the three cards configuring the player's cards are constituted of number “7” of the “same suit”. In the player's cards of the target player terminal, in the case where a combination relating to the “Pontoon” game of the “Super Bonus”, the CPU 41 determines a “jack pot” as the bonus payment. In this case, the CPU 41 gives “the pool amount pooled in the pot” as the bonus payment.

The “5-card Trick” is a combination in the “Pontoon” game achieved in the case where 5 cards configure the player's cards and a total of numbers of the player's cards is equal to or smaller than “21”. In the player's cards of the target player terminal, in the case where a combination relating to the “Pontoon” game of the “5-card Trick” is achieved, the CPU 41 gives a credit of 250” as the bonus payment.

“7, 7, 7” are cards when all of the three cards configuring the player's cards are “seven”, and a combination in the “Pontoon” game achieved in the case where two or more types of suits are included in the player's cards. Therefore, it does not correspond to both of the “Super Bonus” and “7, 7, 7”. In the player's cards of the target player terminal, in the case where a combination relating to the “Pontoon” game of “7, 7, 7” is achieved, the CPU 41 gives a credit of “200” as the bonus payment.

In addition, “6, 7, 8” is a combination in the “Pontoon” game achieved in the case where the numbers of the three cards configuring the player's cards are “6”, “7”, “8”. In this case, any types of suits of cards configuring the player's cards are available. Therefore, a combination of “6, 7, 8” is achieved in “6”, “7”, “8” of the same suit and is also achieved in “6”, “7”, “8” of the different suits. In the player's cards of the target player terminal, in the case where a combination relating to the “Pontoon” game of “6, 7, 8” is achieved, the CPU 41 gives a credit of “150” as the bonus payment.

The “Pontoon” is a combination in the “Pontoon” game achieved in the case where the player's cards are constituted of two cards, i.e., cards whose number is “A” and 10-point cards (i.e., “10”, “J”, “Q”, “K”). In the player's cards of the target player terminal, in the case where a combination of “Pontoon” is achieved, the CPU 41 gives a credit of “100” as the bonus payment.

In a bonus payment judging process (S18), after determining the presence or absence of the bonus payment and the contents of the bonus payment, the CPU 41 transmits a bonus judgment result to the target player terminal (S19). In this context, as the bonus judgment result, information such as types of achieved combinations, the contents of the bonus payment (credit amount to be given, for example) is transmitted.

After the bonus judgment result has been transmitted to each target player terminal, the CPU 41 terminates the game processing program in the main control unit 31.

By transmitting the bonus judgment result to the target player terminal, the result of bonus judgment such as types of achieved combinations and the contents of the bonus payment is displayed on the liquid crystal display 10 of the target player terminal. In addition, the target player terminal carries out a variety of effects corresponding to the bonus judgment result (such as video image effects in the liquid crystal display 10) (S118).

Then, at the target player terminal, payment of awards acquired in the current game is carried out based on the result of winning and losing judgment and/or the bonus judgment result.

Next, the game processing program executed at the side of the player terminal 4 will be described with reference to FIG. 9 to FIG. 11. When execution of the game processing program is started, in S101, the CPU 51 receives the betting period start instruction from the main control unit 31.

After that, when the current step proceeds to S102, the CPU 51 displays the game screen 70 (refer to FIG. 6 and FIG. 7) on the liquid crystal display 10, and starts reception of a betting operation. In this manner, at the player terminal 4, the player can make a betting operation (side bet relating to Blackjack and side bet relating to the bonus payment). In the case where a betting operation has been made, the CPU 51 specifies a betting amount (credit amount) betted or the betting amount relating to a side bet, based on the operational information from the touch panel 11.

Then, after the specified betting amount has been stored as the betting information in the RAM 52, the CPU 51 proceeds to S103.

In S103, the CPU 51 judges whether or not a betting period has terminated. Specifically, the CPU 51 makes judgment as to whether or not a predetermined given time (20 seconds, for example) has been passed after starting reception of the betting operation (i.e., reception of the betting period start instruction). In the case where the betting period has terminated (S103: YES), the CPU 51 proceeds to S104. On the other hand, in the case where the betting period has not terminated (S103: NO), the CPU 51 continuously receives the betting operation.

When the current step proceeds to S104, the CPU 51 stores the current betting information in the RAM 52, and transmits the betting information to the main control unit 31. The betting information includes information relating to the betting amount (credit amount) betted by the player and information relating to the side bet.

Then, in S105, the CPU 51 receives the initial card information. The received initial card information is information to be transmitted from the main control unit 31 to the player terminal 4 in accordance with S6. Then, the initial card information is information on the first and second cards associated with the player who plays the game at the player terminal. Therefore, the initial card information includes information on numbers and suits according to two initial cards (such as “Heart 7”, “Spade A”, for example).

Upon the reception of the initial card information, the CPU 51 displays two initial cards in a player's card display area 71 of the game screen 70, based on the initial card information (S106).

After that, when the current step proceeds to S107, the CPU 71 starts reception of operation of various operating buttons displayed on the game screen 70. In other words, following the processing operation of S107, the player can operate the STAND button 78, the HIT button 79, the SURRENDER button 80, the INSURANCE button 81, the SPLIT button 82, and the Double Down button 83. In this manner, the player can enjoy an underlying strategy with the dealer with respect to the Blackjack game.

Then, in S108, the CPU 51 makes judgment as to whether or not the HIT button 79 has been operated. In the case where the HIT button 79 has been operated (S108: YES), the CPU 51 transmits the additional card information request for requesting distribution of new cards to the main control unit 31 (S109). After the additional card information request has been transmitted, the CPU 51 receives the additional card information transmitted from the main control unit 31 (S110). At this time, the CPU 51 displays cards newly added as the player's cards in the player's card display area 71, based on the received additional card information (S111).

On the other hand, in the case where the HIT button 79 has not been operated (S108: NO), the CPU 51 proceeds to S112.

In the following S112, the CPU 51 makes judgment as to whether or not the STAND button 78 has been operated. In the case where the STAND button 78 has been operated (S112: YES), the CPU 51 transmits the card determination information to the main control unit 31 (S113). By transmitting the card determination information, the player determines to play the game with cards currently displayed in the player's card display area 71.

On the other hand, in the case where the STAND button 78 has not been operated (S112: NO), the CPU 51 returns to S108.

In the case where any of the other operating buttons (namely, SURRENDER button 80, INSURANCE button 81, SPLIT button 82, Double Down button 83, and HELP button 84) has been operated, the CPU 551 carries out the processing operation responsive to the button operated.

Next, when the current step proceeds to S114, the CPU 51 receives the result of winning and losing judgment transmitted from the main control unit 31 in S13. After that, the CPU 51 displays the result of winning and losing judgment obtained at the player terminal 4 on the liquid crystal display 10, based on the received result of winning and losing judgment (S115). Specifically, in the case where the game result is a draw, the CPU 51 displays characters “DRAW” in the winning and losing display area 95 of the game screen 70 (refer to FIG. 1). Similarly, the CPU 51 displays characters “YOU WON” in the case where the player has won, and displays characters “YOU LOST” in the case where the player has lost.

After the result of winning and losing judgment has been displayed in the winning and losing display area 95, the CPU 51 makes judgment as to whether or not a side bet has been made at the target player terminal (S116). Specifically, the CPU 51 judges the presence or absence of a side bet from the betting information by referring to the betting information stored in the RAM 52. In other words, in S116, judgment is made as to whether or not the player terminal 4 becomes the “target player terminal” described above. In the case where a side bet is made (S116: YES), the CPU 51 proceeds to S117.

On the other hand, in the case where a side bet is not made (S116: NO), the CPU 51 proceeds to a payout processing (S119) directory. In this case, at the player terminal 4, the payment responsive to the result of winning and losing judgment of Blackjack is paid out.

After that, in S117, the CPU 51 receives a bonus judgment result transmitted from the main control unit 31. The received bonus judgment result is a judgment result relating to the achievement of the combination according to the “Pontoon” game in the player's card of the player terminal 4 in the bonus payment judgment process (S18). Then, this bonus judgment result includes the presence or absence of the bonus payment and the contents of the achieved combination.

Upon the reception of the bonus judgment result, the CPU 51 displays a judgment result such as “the presence or absence of the bonus payment” on the game screen 70, based on the bonus judgment result (S118).

For example, in the case of the example shown in FIG. 1, the player's cards are constituted of “Diamond 7”, “Heart 7”, and “Club 7”. In other words, in the player's cards, the combination of “7, 7, 7” is achieved. In this case, in the processing operation of S118, the CPU 51 displays a character string of “BONUS GET!!” in the winning and losing display area 95 (refer to FIG. 1).

At this time, “7, 7, 7” is displayed on the game screen 70 together with the displayed contents in the winning and losing display area 95 so that the player's cards can be arranged to notify the “achieved combination” to the player.

After the bonus judgment result has been displayed on the game screen 70, the CPU 51 executes the payout processing (S119). In this payout processing (S119), the CPU 51 carries out an adding operation of credits or payout of coins, based on the result of winning and losing judgment and the bonus judgment result. In other words, in the case where S116 proceeds to the payout processing (S119), the CPU 51 carries out the adding operation of credits or payout of coins, only based on the result of winning and losing judgment. On the other hand, through S117 and S118, in the case where the current step proceeds to the payout processing (S119), the CPU 51 execute the adding operation of credits or payout of coins, based on the “result of winning and losing judgment” and the “bonus judgment result”. In other words, the CPU 51 gives the player the “payment based on the result of winning and losing judgment” and the “payment based on the bonus judgment result”.

By the achievement of “Super Bonus”, in the case where a “jack pot” is determined as the bonus judgment result, the CPU 51 gives “the pool amount pooled in the pot” as the bonus payment in the payout processing (S119). At this time, the “pool amount pooled in the pot” is reset to an initial value (300, for example). In this regard, it is possible to set the initial value of the pool amount to “0”.

In the player's cards of a plurality of players, in the case where the combination of “Super Bonus” has been achieved at the same time, the pool amount is equally distributed and paid out by the corresponding number of players (the number of players when “Super Bonus” is achieved).

As has been described above, in the card gaming machine 1 and the card game playing method according to the present embodiment, the judgment of winning and losing is made by way of comparison between the player's cards and the dealer's cards on condition that the player's betting is made, and the Blackjack game is carried out such that the payment is provided based on the result of the judgment of winning and losing.

When a side bet is made to the game, a chance to acquire the bonus payment is given to the player who has made the side bet. In other words, the player can obtain a change to acquire the bonus payment by making a side bet. Therefore, the card gaming machine 1 and the card game playing method can enhance the sense of expectations to the game of the player.

The presence or absence of the bonus payment and the contents of the payment are determined based on whether or not the combination relating to the “Pontoon” game in the cards configuring the player's cards is achieved. In the context, the “Pontoon” game is a game different from the Blackjack game. In other words, at the time of determining the presence or absence of the bonus payment, a criterion different from that for the Blackjack game is introduced. In this manner, the card gaming machine 1 can enhance the sense of expectations to the game of the player while giving new attractions to the player.

In the card gaming machine 1 and the card game playing method according to the present embodiment, in the case where a side bet is made, judgment of the combination in the player's card is made regardless of the result of winning and losing judgment, and the bonus payment is provided in accordance with the achieved combination. In other words, a chance to acquire the bonus payment is given regardless of the result of winning and losing judgment in Blackjack. In other words, the player can obtain a change to acquire the bonus payment only by making the side bet, so that the card gaming machine 1 and the card game playing method can enhance the sense of expectations to the game of the player.

For example, in the case where the player has won against the dealer, a case in which the bonus payment can also be acquired together with the payment obtained by winning can occur. In this case, the card gaming machine 1 and the card game playing method enhance the sense of expectations of the player who desires acquisition of more awards. In addition, even in the case where the player has lost against the dealer, although the payment due to winning cannot be obtained, a case of acquiring the bonus payment can occur. In this case, the card gaming machine 1 and the card game playing method can provide the sense of expectations to the bonus payment to the player who lost the game. In other words, even in this case, the card gaming machine 1 and the card game playing method will not adversely affect the attractions of the game significantly.

The present invention is not limited to the embodiments described previously, and of course, various alterations and modifications can occur without departing from the spirit of the present invention.

For example, while, in the present embodiment, bonus judgment has been made in accordance with whether or not the combination of “Pontoon” games has been achieved, the present invention is not limited to this aspect. In other words, the present invention may be constructed so as to make the bonus judgment based on a first game for judging the winning and losing in comparison with the player's cards and the dealer's cards (Blackjack in the present embodiment) and the combination in another game different from the first game. For example, in the case where “Blackjack” is carried out as a first game, the judgment relating to the bonus payment can be made based on the combination or the like of “Poker”, “Baccarat”.

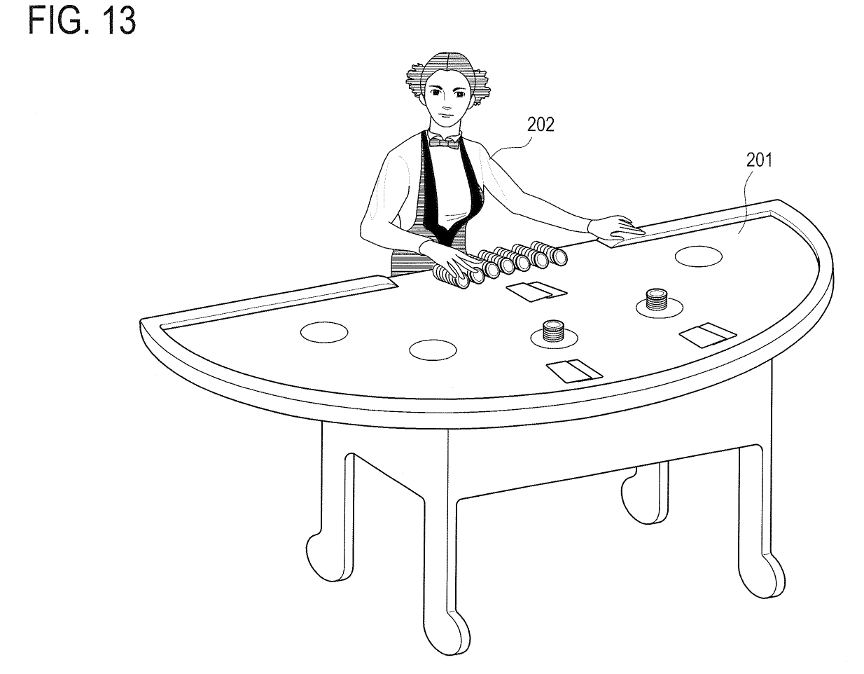

In addition, the card game playing method according to the present invention can also be applied to Blackjack (so called table game) in which a dealer 202 and a player (not shown) play on a gaming table 201, as shown in FIG. 13.

In the table game shown in FIG. 13, the dealer 202 distributes cards to the dealer and players, respectively, on the gaming table 201. On the other hand, the players make a betting operation by placing tips in a predetermined site of the gaming table 201. At this time, the players can make a side bet by placing tips at the predetermined site in the same manner.

Then, the payout to the players is carried out based on the winning and losing of the player's cards and the dealer's cards. In the case where the result of winning and losing becomes a draw, the betting amount is pooled by collecting the tips that have been betted by the players, in the predetermined site (pot) on the gaming table 201.

In the case where the players make a side bet, the dealer makes judgment relating to the achievement of the combination of the “Pontoon” game in the player's cards by referring to numbers and suits of the player's cards. In the case where the combination of the “Pontoon” game is achieved, the dealer gives the player the bonus payment according to the achieved combination.

At this time, the pool amount is paid out to the players by the dealer 202 when the combination of “Super Bonus” has been achieved by giving the tips collected in the predetermined site.

Further, in the card gaming machine and the card game playing method according to the present invention, a first game is not limited to “Blackjack”. In other words, the present invention can be applied to a card gaming machine and a card game playing method, in which a card game called “Pai Gow Poker” or “Draw Poker” can be executed as a first game.

What is claimed is:

1. A card gaming machine comprising:
a display for displaying a plurality of cards;
an operating unit for receiving an input information from a player; and
a game controller for executing the steps of:
(a) receiving a betting of a gaming value by the player;
(b) making judgment of winning and losing by comparing the player's cards constituted of cards associated with the player with the dealer's cards constituted of cards associated with the dealer from among a plurality of cards displayed on the display;
(c) executing a first game for providing to the player a first award that is based on a betted gaming value in response to a result of the judgment of winning and losing;
(d) receiving a side bet of a gaming value by the player
(e) in a case where the side bet is made, judging whether or not a specified predetermined combination is achieved as a combination in a game different from the first game by cards configuring the player's cards; and
(f) providing a second award responsive to the achieved combination.

2. A card gaming machine comprising:
a display for displaying a plurality of cards;
an operating unit for receiving an input information from a player; and
a game controller for executing the steps of:
(a) receiving a betting of a gaming value by the player;
(b) making judgment of winning and losing by comparing the player's cards constituted of cards associated with the player with the dealer's cards constituted of cards associated with the dealer from among a plurality of cards displayed on the display;
(c) executing a Blackjack game as a first game for providing to the player a first award that is based on a betted gaming value in response to a result of the judgment of winning and losing:
(d) receiving a side bet of a gaming value by the player
(e) in a case where the side bet is made, judging whether or not a specified predetermined combination is achieved as a combination in a game different from the Blackjack game by cards configuring the player's cards; and
(f) providing a second award responsive to the achieved combination.

3. The card gaming machine according to claim 1, wherein
the game controller executes the step of:
in a case where the side bet is made, making judgment relevant to achievement of the combination in cards configuring the player's cards, and providing the second award responsive to the achieved combination, regardless of the presence or absence of a first award in the first game.

4. The card gaming machine according to claim 2, wherein
the game controller executes the step of:
in a case where the side bet is made, making judgment relevant to achievement of the combination in cards configuring the player's cards, and providing the second award responsive to the achieved combination, regardless of the presence or absence of a first award in the first game.

5. A card game playing method comprising the steps of:
(a) receiving a betting of a gaming value by a player;
(b) making judgment of winning and losing by comparing the player's cards constituted of cards associated with the player with the dealer's cards constituted of cards associated with a dealer from among a plurality of cards displayed on the display;
(c) executing a first game for providing to the player a first award that is based on a betted gaming value in response to a result of the judgment of winning and losing;
(d) receiving a side bet of a gaming value by the player
(e) in a case where the side bet is made, judging whether or not a specified predetermined combination is achieved as a combination in a game different from the first game by cards configuring the player's cards; and
(f) providing a second award responsive to the achieved combination.

6. A card game playing method comprising the steps of:
(a) receiving a betting of a gaming value by a player;
(b) making judgment of winning and losing by comparing the player's cards constituted of cards associated with the player with the dealer's cards constituted of cards associated with a dealer from among a plurality of cards displayed on the display;
(c) executing a Blackjack game as a first game for providing to the player a first award that is based on a betted gaming value in response to a result of the judgment of winning and losing:
(d) receiving a side bet of a gaming value by the player
(e) in a case where the side bet is made, judging whether or not a specified predetermined combination is achieved as a combination in a game different from the Blackjack game by cards configuring the player's cards; and
(f) providing a second award responsive to the achieved combination.

7. The card game playing method according to claim 5, comprising the step of:
in a case where the side bet is made, making judgment relevant to achievement of the combination in cards configuring the player's cards, and providing the second award responsive to the achieved combination, regardless of the presence or absence of a first award in the first game.

8. The card game playing method according to claim 6, comprising the step of:
in a case where the side bet is made, making judgment relevant to achievement of the combination in cards configuring the player's cards, and providing the second award responsive to the achieved combination, regardless of the presence or absence of a first award in the first game.
